(19) United States
(12) Patent Application Publication
(10) Pub. No.: US 2002/0086123 A1
(43) Pub. Date: Jul. 4, 2002

(54) Method for making a container having a compartment

(76) Inventors: Robert F. Glaser, Agoura Hills, CA (US); Clifford T. Rosenberg, Hong Kong (CN)

Correspondence Address: KENNEDY, DAVIS & HODGE, LLP, 5 CONCOURSE PARKWAY, SUITE 900, ATLANTA, GA, 30328, US

(21) Appl. No.: 09/754,029

(22) Filed: Jan. 2, 2001

(51) Int. Cl. B65D 1/00; B29C 49/06

(52) U.S. Cl. 428/36.9; 264/537

(57) ABSTRACT

A method for manufacturing a container (10) for holding at least one good in a space (12) with a separate compartment (14) for holding a novelty article that is selectively accessed, in which a first portion of the container is defined in an injection mold by molding a parason with thermoplastic resin around a mandrel and while the thermoplastic resin is still hot, transferring the parason to a blow mold; and injecting compressed air into the mold to force thermoplastic resin of the parason to take the shape of the mold cavity for defining a second portion of the container having the separate compartment. A container made by the method is disclosed.

### TECHNICAL FIELD

The present invention relates to methods for making containers that hold materials, particularly such as beverage fluids, for dispensing from the container. More particularly, the present invention relates to methods for manufacturing containers that hold fluid or solid materials in a cavity for dispensing while and with a separate selectively accessed compartment for also enclosing a novelty article.

### BACKGROUND OF THE INVENTION

People often consume foods and drinks while at public activities such as amusement parks and sporting events. Often at such facilities, the drinks are available in a stylized theme-related container. For example, the container may include ornamental graphics that relate to the amusement park or that bear brand insignia of the sporting team. The beverages held in these containers are often sold at a premium because the container is a “souvenir” for the person consuming the beverage to retain and carry home as a remembrance of the activity or event.

In addition to using containers that bear ornamental graphics as a further inducement to purchasers of beverages, marketing techniques for the sale of goods or services also include the use of premiums to promote these sales. For example, advertising and promotional campaigns in support of major motion pictures often include “tie-ins” of goods or services offered by other companies. The term “tie-in” refers to the practice of associating goods and services of others with the characters or plot of the movie. The purpose is to increase the sales of the other goods and services and to cross-market with the movie. These other companies pay licensing fees for the right to advertise, market, and sell the “tie-in” products and services associated with the motion picture, its characters, and plot. The use of premiums as “tie-ins” for sales of goods is often used in the fast food industry, but are used in other retail environments as well. For example, fast food stores typically offer a children's meal together with a premium as an inducement to purchase these foods at the store, and thereby increase the overall sales. Often the premium is enclosed in a separate container and placed with the food products for delivery to the consumer. The premiums typically are novelty items associated with the advertising and marketing program of another. The novelty article often takes the form of a figurine, toy, or article related to or involved with the motion picture or a similar promotion for consumers.

Our earlier U.S. Pat. No. 5,996,781 discloses a drink container having a separate compartment for enclosing a novelty article. The compartment is separately selectively accessed, whereby the novelty article or premium may be removed, while the container continues to function for its intended purpose of holding a drink. While this container has been successful for its intended purpose, the manufacturing costs have tended to limit its use to specific promotional activities. Use of the container that holds a beverage while permitting selective access to the novelty article would be more widespread in ordinary and routine amusement park, sporting goods, movie promotion, and the like kind of activities, with provision of containers by a more economical manufacturing process.

Accordingly, there is a need in the art to provide a method of manufacturing a container that holds materials for dispensing with the separately selectively accessed compartment of such container enclosing a selectively accessed novelty article. It is to such that the present invention is directed.

### SUMMARY OF THE INVENTION

The present invention meets the needs of the art by providing a method for manufacturing containers that function to hold a first material in a space defined by walls of the container with a separate selectively accessed compartment for containing at least one separate article, comprising the steps of (a) defining a first portion of the container in an injection mold by molding a parason with thermoplastic resin around a mandrel; (b) while the thermoplastic resin is still hot, transferring the parason to a blow mold; and (c) injecting compressed air into the mold to force thermoplastic resin to take the shape of the mold cavity for defining a second portion of the container.

The present invention discloses a container that functions to hold a first material in a space defined by walls of the container and with a separate selectively accessed compartment for containing at least one separate article, which container is made by the method described above.

Objects, advantages, and features of the present invention will become apparent from a reading of the following detailed description of the invention and claims in view of the appended drawings.

### BRIEF DESCRIPTION OF THE DRAWINGS

FIG. 1 is perspective partially cut-away view of a container according to the present invention.

FIG. 2 is a cross-sectional partially cut-away view of the container illustrated in FIG. 1 to show features of the container.

FIG. 3 is a cross-sectional view of a first mold used in the process for manufacturing the container illustrated in FIG. 1.

FIG. 4 is a cross-sectional view of a second mold used during the process for manufacturing the container illustrated in FIG. 1.

FIG. 5 is a cross-sectional view of the second mold used during the process for manufacturing the container illustrated in FIG. 1.

### DETAILED DESCRIPTION OF THE PRESENT INVENTION

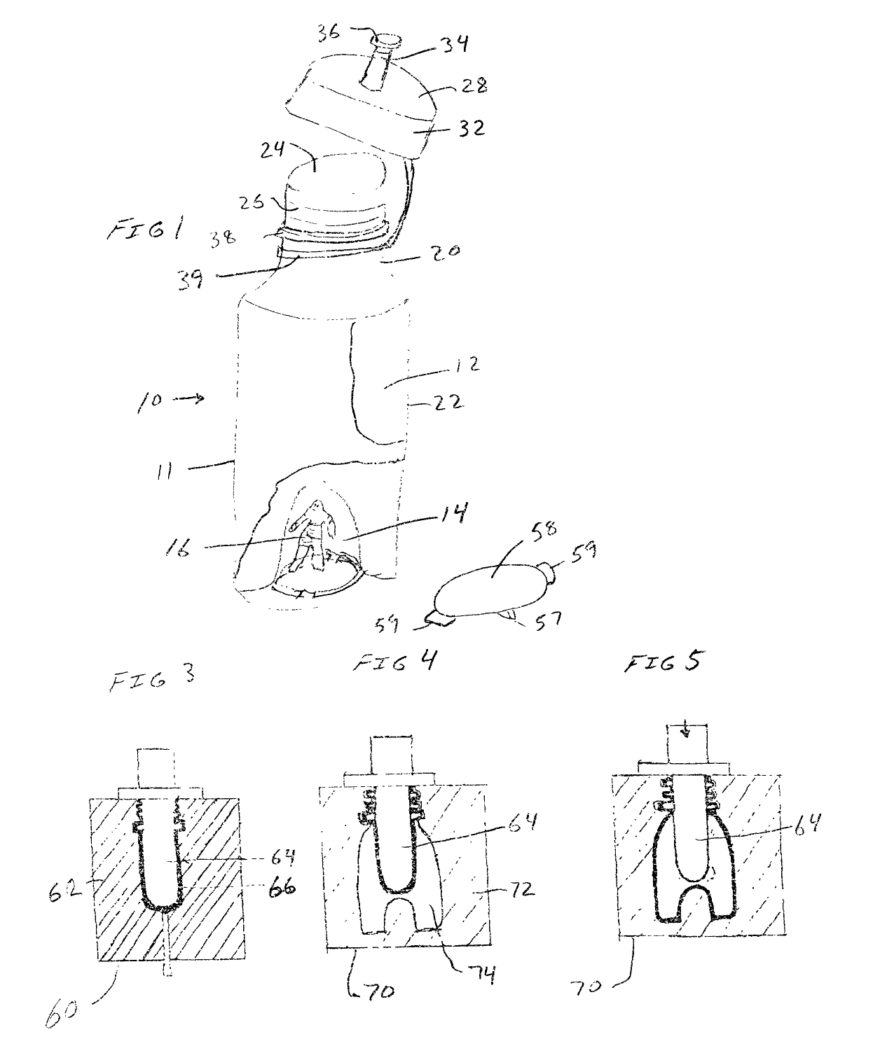

Referring now in more detail to the drawings, in which like numerals indicate like parts throughout the several views, FIG. 1 illustrates in perspective partially cut-away view a container 10 constructed in accordance with the present invention. The container 10 is defined by a side wall generally 11 that functions to hold goods such as fluids or solids materials in a cavity 12. The container 10 also provides a selectively accessed compartment 14 for enclosing a novelty article or premium 16 such as the illustrated figurine.

The container 10 in the illustrated embodiment comprises a bottle, of a type commonly provided water bottle. The container 10 includes a necked portion 20 and a body portion 22 that defines the cavity 12 for holding the water, beverage fluids, or even particulate solids. A distal end 24 of the neck portion 20 is open. The necked portion 20 defines a threaded exterior 26 for receiving a cap 28 having an interior thread on a skirt 32. A spout 34 includes a selectively removable nozzle 36 to open and close the spout 34 for communication of fluids from the container 10. The mechanisms of the cap 28 and the spout 34 are conventional and not otherwise discussed herein. The compartment 14 is disposed in a lower portion of the body 22.

FIG. 2 is a cross-sectional partially cut-away view of the container 10 illustrated in FIG. 1, to illustrate features of the container according to the present invention. The necked portion 20 includes a radially extending flange 38 longitudinally spaced from the open end 24 of the body 22. A linking ring 39 (illustrated in FIG. 1) attaches to the cap 28. The linking ring 39 is received over the flange 38 on the necked portion 20, whereby the cap 28 may be removed from closing the necked portion yet not be detached from the container 10.

The body 22 terminates in a base 40. In the illustrated embodiment, the base 40 defines an annular ring with an opening 44 to the compartment 14. The compartment 14 is defined by a wall 50 extending from the base 40 inwardly of the body 22. In the illustrated embodiment, the wall 50 defines a generally conical or bell-shaped cavity with inwardly tapering walls terminated by a dome or arcuate-shaped end 52. A flange 54 extends radially inwardly from the wall 50 at the opening 44. The flange 54 is near the base 40, but preferably recessed inwardly of the body 22 relative to the exterior surface of the base 40, for a purpose discussed below. The interior wall 50 further defines a radially extending notch or recess 56 about the wall adjacent the flange 54. The recess 56 is defined by cooperating portions of the flange 54 and the wall 50. A closure member or cap 58 is received in the opening 44 to close the cavity 14. The cap 58 includes a radially extending flange 59 and a finger grip 57. The flange 59 is received within the recess 56 to secure the cap 58 to the body 12. The flanges 59 pass by slots 61 in the flange 54 into the recess 56.

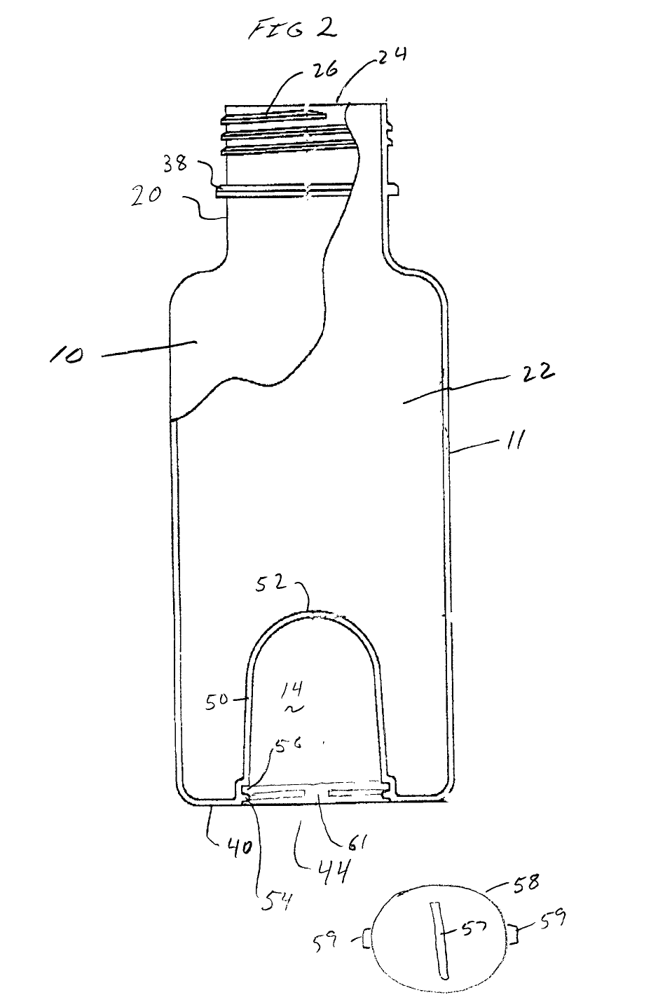

FIG. 3 is a cross-sectional view of a first mold 60 used in the process for manufacturing the container 10. The first mold 60 includes a mold body 62 which receives a mandrel 64. The first mold 60 defines a cavity 66 having a cross-sectional shape of the necked portion 20 of the container 10. The first mold is an injection moldig apparatus.

FIG. 4 is a cross-sectional view of a second mold 70 used in the process for manufacturing the container 10. The second mold 70 includes a mold body 72 that defines a cavity 74 conforming in shape to the body 22 of the container 10. The second mold 70 is a blow molding apparatus.

FIG. 5 is a cross-sectional view of the second mold 70 illustrating aspects of the manufacturing process according to the present invention. As illustrated, the body 22 of the container 10 is defined by forcing the thermoplastic resin to the walls of the cavity 74.

With reference to FIG. 3, the process of manufacturing the bottle 10 is described below. The mandrel 64 closely conforms to the cavity in the mold body 62 for defining the wall 11 of the container 10 by a gap between the mandrel 64 and the interior wall of the mold cavity 66. The mandrel 64 is first received in the first mold 60. Thermoplastic resin is injected in the gap between the mandrel 64 and the mold body 62. The thermoplastic resin is hot, so that the resin is fluidal. The resin fills the gap. The injection molded thermoplastic conforms to the shape of the mold body 62, and thereby defines the necked portion 20 of the container 10.

As shown in FIG. 4, while the thermoplastic resin is still hot, the plastic blank, known as a parason, is transferred to the second mold 70. Compressed air is communicated through the mandrel to force the still-hot thermoplastic resin away from the mandrel 64 to the walls of the die cavity 72, as illustrated in FIG. 5. This defines the body portion 22 of the container 10 including the compartment 14. Upon cooling and solidification of the thermoplastic resin, the second mold 70 is opened and the container 10 is removed.

The manufacturing process of present invention provides containers for holding fluids such as beverages in which containers are defined with the separate compartment for holding a premium or novelty article that is selectively accessible within the container while the container functions for its primary purpose of holding the beverages. The container is manufactured in a two-step process whereby the necked portion is first formed and the body portion and the cavity for the novelty article are subsequently formed. It is to be appreciated that other containers such as drinking cups and shapes of containers are readily manufactured according to the present invention.

The container 10 is used for holding the beverage, such as water, in the cavity 12 and closed by the cap 28. In other containers of the present invention, the cap may be a snap-on lid or a screw-on cap. The novelty article 16 is placed in the compartment 14 and closed by the cap 58. The opening 44 includes the slots 61 to receive the flanges 59 of the cap 58 into the recess 56. The finger grip 57 in the illustrated embodiment facilitates operating the cap 58 to the open and closed positions in the opening 44. The recess 56 conventionally includes detents for engaging the flanges 59 and holding the cap in a closed position. In an alternate embodiment, the opening 44 is closed by a selectively detached cover made of a flexible sheet having an adhesive perimeter for engaging the flange 54 or the base 50 (in such embodiments that do not include the flange 54.) The sheet material may be of paper, foam, plastic, or the like.

In yet another alternate embodiment, the opening 44 is closed by a resilient plug received therein. The plug may include a notch for being gripped by fingers in order to remove the plug.

The principles, preferred embodiments, and modes of operation of the present invention have been described in the foregoing specification. The invention is not to be construed as limited to the particular forms disclosed because these are regarded as illustrative rather than restrictive. Moreover variations and changes may be made by those skilled in the art without departure from the spirit of the invention as described by the following claims.

What is claimed is:

1. A method for manufacturing a container for holding at least one good in a space defined by the walls of the container while permitting selective access to at lest one article in a separate compartment defined therein, comprising the steps of:
(a) defining a first portion of the container in an injection mold by molding a parason with thermoplastic resin around a mandrel;
(b) while the thermoplastic resin is still hot, transferring the parason to a blow mold; and
(c) injecting compressed air into the mold to force the mold into a thermoplastic resin to take the shape of the mold cavity for defining a second portion of the container.

2. A container made by the method recited in claim 1.
